(19) United States
(12) Patent Application Publication
(10) Pub. No.: US 2011/0122118 A1
(43) Pub. Date: May 26, 2011

(54) DISPLAY DEVICE

(75) Inventors: Yoshihiro Kotani, Chiba (JP); Takeshi Shibata, Mobara (JP); Gou Yamamoto, Mobara (JP); Kouichi Kotera, Kokubunji (JP); Masato Ishii, Tokyo (JP); Norio Mamba, Kawasaki (JP)

(73) Assignees: Hitachi Displays, Ltd.; Canon Kabushiki Kaisha

(21) Appl. No.: 12/951,164

(22) Filed: Nov. 22, 2010

(30) Foreign Application Priority Data
Nov. 24, 2009 (JP) 2009-266497

(51) Int. Cl. G09G 5/00

(52) U.S. Cl. 345/211

(57) ABSTRACT

To obtain a display device that can perform measurements in a wider range and detect characteristic changes with high accuracy while suppressing the increase in circuit size. The display device includes display elements and a characteristic testing unit that tests characteristics of the display elements, and the characteristic testing unit includes a current supply unit for the display element as a target of test, a reference voltage output unit, an output voltage detecting unit that detects a code of a voltage of the test target display element relative to the reference voltage at each time, and a test control unit that allows the reference voltage output unit to sequentially output the reference voltages in response to the codes and acquires a measurement result of the voltage of the test target display element based on the codes.

### CROSS-REFERENCE TO RELATED APPLICATION

The present application claims priority from Japanese patent application JP 2009-266497 filed on Nov. 24, 2009, the content of which is hereby incorporated by reference into this application.

### BACKGROUND OF THE INVENTION

1. Field of the Invention

The present invention relates to a display device, and specifically, to improvements of display quality in the display device and longer life of the display device by control of correction of characteristic changes of display elements.

2. Description of the Related Art

A display device performs display by controlling amounts of currents flowing in display elements, for example. The characteristics of the display elements may vary from element to element. Further, deterioration over time may occur in use of the elements and their characteristics may change.

For example, in a display device, when a certain fixed image is continuously displayed, deterioration over time may occur in particular display elements, the characteristics of the display elements may change, and there may be differences in characteristics among the display elements provided in the display device. Thereby, for example, if the same control is performed on all of the display elements in a display area to perform display by all display elements with the same brightness, there may be differences in display brightness due to the differences in the characteristics of the display elements. The differences in display brightness may be recognized as “burn-in phenomenon” by human eyes. Thereby, the display quality of the display device may become lower and the life of the display device may be shorter.

A technology to suppress the “burn-in phenomenon” and suppress the reduction in display quality is disclosed in JP 2008-102404 A. The display device disclosed in JP 2008-102404 A suppresses the “burn-in phenomenon” by detecting conditions of the display elements with respect to each display element and correcting amounts of control for the elements based on the detection results depending on the degrees of deterioration.

### SUMMARY OF THE INVENTION

The display device disclosed in JP 2008-102404 A includes detection circuits that detect deterioration of the elements. The detection circuits, at detection of the display elements, detect degrees of deterioration of the display elements by allowing currents to flow in the display elements using a test power supply and testing the characteristics of the amounts of currents flowing in the display elements and the voltages between opposite poles. The device corrects the amounts of control for the display elements by AD-converting the degrees of deterioration. For example, the current and voltage characteristics of the display elements may have wide temperature characteristics. In addition to the characteristic variations, the characteristics vary due to deterioration. In the case of the display device including the display elements, in the test of the display elements, a wide test voltage range is required.

In the display device, for high accuracy correction, to perform measurements in a wide test voltage range and improve the accuracy at detection of characteristic changes, the circuit size of the test circuit enormously increases. However, in JP 2008-102404 A, the problem of the increase in circuit size is not mentioned.

In view of the above described problem, a purpose of the invention is to provide a display device that can perform measurements in a wider voltage range and detect characteristic changes of display elements with high accuracy while suppressing the increase in circuit size of a test circuit of the elements.

(1) In order to solve the problem, a display device according to the invention is a display device including plural display elements that perform display by control of amounts of flowing currents, a characteristic testing unit that tests current and voltage characteristics of the respective display elements, and a display control unit that applies signal voltages to the display elements based on display data to be displayed on the display elements and the characteristics tested by the characteristic testing unit, and the characteristic testing unit includes a current supply unit that supplies a test current to the display element as a target of test as one of the plural display elements, a reference voltage output unit that outputs reference voltages, an output voltage detecting unit that detects a code of a voltage of the test target display element relative to the reference voltage at each time when the reference voltage is output from the reference voltage output unit, and a test control unit that allows the reference voltage output unit to sequentially output the reference voltages in response to the codes and acquires a measurement result of the voltage of the test target display element based on the codes.

(2) In the display device according to (1), the reference voltage output unit may include a first reference voltage output unit that generates a first reference voltage by internally dividing a predetermined first criterion voltage range, the test control unit may acquire a first measurement result of the voltage of the test target display element based on the codes detected using the first reference voltage output by the first reference voltage output unit as the reference voltage, the reference voltage output unit may further include a second reference voltage output unit that generates a second reference voltage by internally dividing a second criterion voltage range determined based on the first measurement result, and the test control unit may acquire a second measurement result of the voltage of the test target display element based on the codes detected using the second reference voltage output by the second reference voltage output unit as the reference voltage and acquire the measurement result of the voltage of the display element based on the second measurement result.

(3) In the display device according to the description (2), the test control unit may allow the reference voltage output unit to output the second reference voltage by internally dividing the second criterion voltage range determined based on the first measurement result of the test target display element, and may further acquire a second measurement result of a voltage of another test target display element based on the codes detected using the second reference voltage as the reference voltage and acquire the measurement result of the voltage of the other test target display element based on the second measurement result.

(4) In the display device according to (2) or (3), accuracy of the first measurement result of the voltage of the test target display element may be contained in the second criterion voltage range.

According to the invention, there is provided a display device that can perform measurements in a wider voltage range and detect characteristic changes of display elements with high accuracy while suppressing the increase in circuit size of a test circuit of the elements.

### BRIEF DESCRIPTION OF THE DRAWINGS

FIG. 1 is a perspective view of a main part of an organic EL display device according to an embodiment of the invention;

FIG. 2 is a schematic diagram showing a drive system related to display of the organic EL display device according to the embodiment of the invention;

FIG. 3 is a schematic circuit diagram showing control of display of organic EL elements and control of characteristic tests of the organic EL elements;

FIG. 4 is a circuit diagram of a burn-in detection circuit provided in the organic EL display device according to the embodiment of the invention;

FIG. 5 shows changes with time of driving of the burn-in detection circuit;

FIG. 6 shows changes with time of driving of the burn-in detection circuit;

FIG. 7 shows a summary of generation of reference voltages by a reference voltage output circuit;

FIGS. 8A and 8B show an example of the case where a burn-in phenomenon occurs;

FIG. 9 shows current and voltage characteristics of the organic EL elements of the organic EL display device according to the embodiment of the invention; and

FIG. 10 shows voltages of the organic EL elements on a common horizontal line.

### DETAILED DESCRIPTION OF THE INVENTION

As below, a display device according to an embodiment of the invention will be explained by taking an organic EL display device as an example with reference to the drawings.

FIG. 1 is a perspective view of a main part of an organic EL display device 1 according to the embodiment of the invention. As shown in FIG. 1, the organic EL display device 1 includes an upper frame 3 and a lower frame 4 that sandwich and secure an organic EL panel including a TFT (Thin Film Transistor) substrate 2 and a sealing substrate (not shown), a circuit substrate 6 provided with a control circuit (e.g., a drive circuit), and a flexible substrate 5 that transmits display data generated in the circuit substrate 6 to the TFT substrate 2. Further, to the circuit substrate 6, currents and voltages necessary for the organic EL panel to display images are supplied from a power supply circuit via the flexible substrate 5.

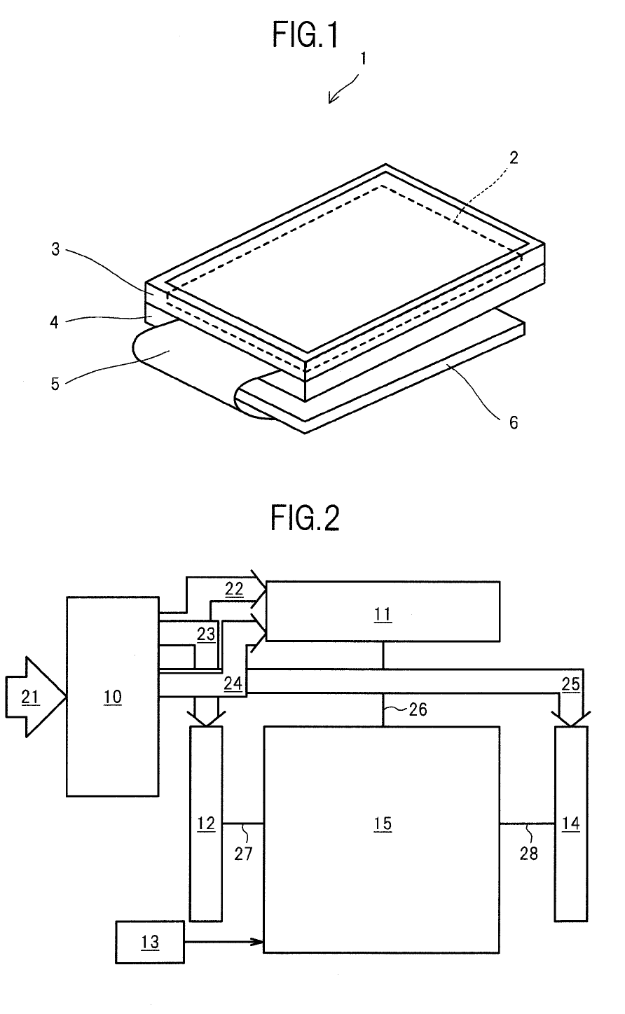

FIG. 2 is a schematic diagram showing a drive system related to display of the organic EL display device 1 according to the embodiment of the invention. To a display control unit 10, display control signals 21 including a horizontal synchronization signal, a vertical synchronization signal, a data enable signal, display data, a synchronization clock signal, etc. are input. The display control unit 10 outputs a data line control signal 22 to a data line drive circuit 11 and a scan line control signal 23 to a scan line drive circuit 12 based on the input display control signals 21.

By the data line drive circuit 11, the scan line drive circuit 12, and a light emission voltage supply circuit 13, plural pixel circuits arranged in a matrix in a display area 15 are controlled. The respective pixel circuits are connected to the data line drive circuit 11 via plural data signal lines 26 and connected to the scan line drive circuit 12 via plural scan lines 27. At writing of display data to the pixel circuits, the scan line drive circuit 12 sequentially applies a high-voltage to the plural scan lines 27. In the pixel circuits connected to the scan line 27 to which the high-voltage is applied, writing of display data is performed. Concurrently, the data line drive circuit 11 supplies display control voltages to the respective pixel circuits via the respective corresponding data signal lines 26. Thereby, at light emission of organic EL elements 201 (not shown) provided in the pixel circuits, the amounts of currents flowing in the organic EL elements 201 are controlled for image display.

Further, the display control unit 10 outputs a detection control signal 24 to the data line drive circuit 11 and outputs a detection scan line control signal 25 to a detection scan line drive circuit 14. The data line drive circuit 11 includes a burn-in detection circuit 100 (not shown) as a characteristic testing unit. In blanking periods in which neither writing of display data in the pixel circuits nor light emission of the organic EL elements 201 of the pixel circuits is performed, the burn-in detection circuit 100 sequentially tests the characteristics of the respective organic EL elements 201 and detects the degrees of deterioration of the elements.

The detection scan line drive circuit 14 connects the organic EL elements 201 as targets of tests to the corresponding data signal lines 26 via plural detection scan lines 28. The burn-in detection circuit 100 allows currents to flow in the organic EL elements 201 via the corresponding data signal lines 26, measures voltages of the elements, and thereby, acquires current and voltage characteristics of the elements.

In FIG. 2, the display control unit 10 and the data line drive circuit 11, the scan line drive circuit 12, and the detection scan line drive circuit 14 are shown as separate parts, however, all or part of them may be mounted on an IC.

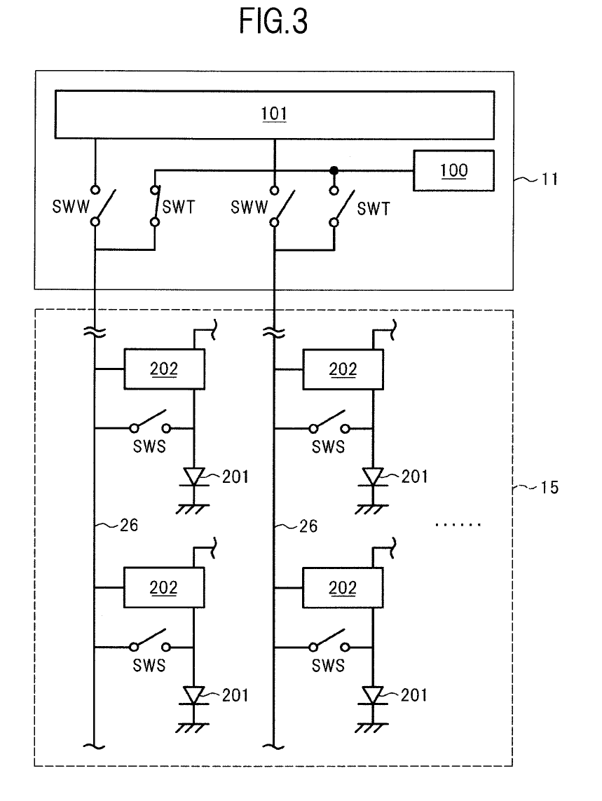

FIG. 3 is a schematic circuit diagram showing control of display of the organic EL elements 201 and control of characteristic tests of the organic EL elements 201. The data line drive circuit 11 includes a data line control voltage supply circuit 101 and the above described burn-in detection circuit 100. Further, the data line control voltage supply circuit 101 and the above described burn-in detection circuit 100 provided in the data line drive circuit 11 are connected to the plural pixel circuits via switching elements SWW, SWT, respectively. In FIG. 3, for simplicity, in each pixel circuit, the organic EL element 201, a display control circuit 202, and a control switching element SWS are shown.

In a data writing period in which display data are written in the pixel circuits, the switching elements SWW are turned on and the switching elements SWT are turned off. Further, in the data writing period, the scan line drive circuit 12 (not shown) turns on the switching elements (not shown) provided in the display control circuits 202 via the scan lines 27 (not shown) and, for the pixel circuits that have been turned on, display control voltages are supplied by the data line control voltage supply circuit 101 to the display control circuits 202 via the corresponding data signal lines 26. Furthermore, in a light emission period in which light is emitted in the display elements, light emission currents are supplied by a light emission current supply circuit (not shown) to the organic EL elements 201 of the pixel circuits and light is emitted.

On the other hand, in a characteristic test period in which characteristics of the organic EL elements 201 of the pixel circuits are tested, the switching elements SWW are turned off and the corresponding switching element SWT is turned on. Further, the detection scan line drive circuit 14 (not shown) turns on the control switching element SWS provided in the pixel circuit of the organic EL element 201 as a target of test via the corresponding detection scan line 28 (not shown), and the burn-in detection circuit 100 tests the characteristics of the organic EL element 201.

The burn-in detection circuit 100 includes a current source and supplies a predetermined test current to the organic EL element 201 as the target of test via the corresponding data signal line 26. Since the anode electrodes of the organic EL elements 201 are grounded, the current and voltage characteristics of the organic EL element 201 are tested by measuring the voltage of the cathode electrode of the organic EL element 201.

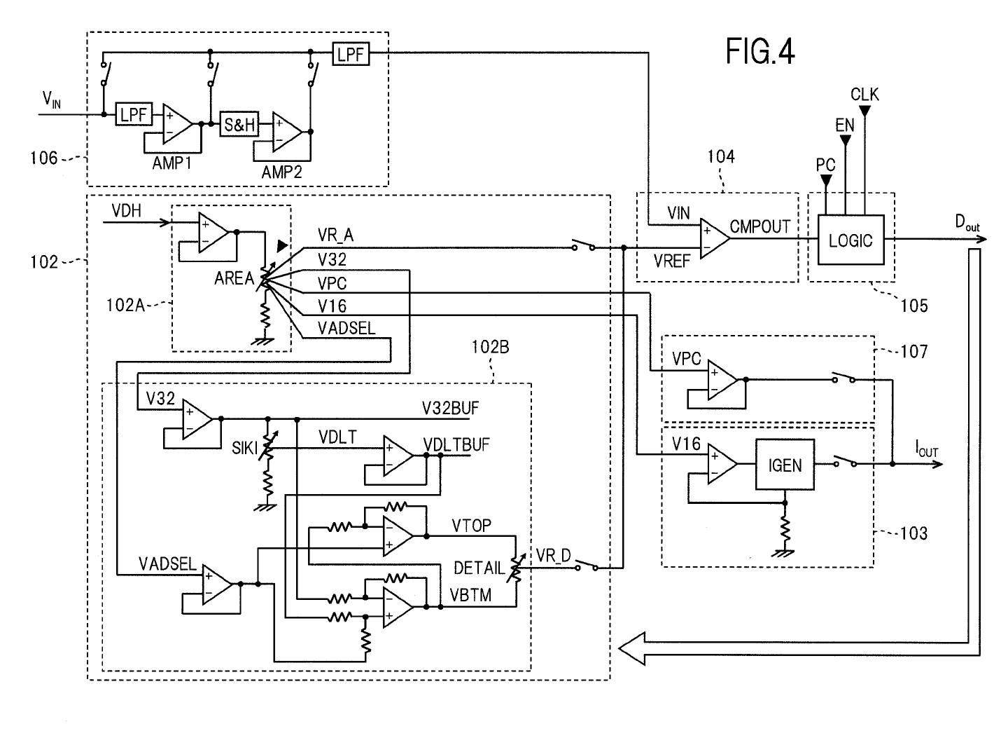

FIG. 4 is a circuit diagram of the burn-in detection circuit 100 provided in the organic EL display device 1 according to the embodiment of the invention. The burn-in detection circuit 100 supplies a detection current to the corresponding organic EL element 201 and converts the voltage of the organic EL element 201 into digital values. As a configuration of AD conversion, the circuit is characterized as a successive approximation register (SAR) AD conversion circuit using only a comparator 104 as an output voltage detecting unit.

As shown in FIG. 4, the burn-in detection circuit 100 includes a reference voltage output circuit 102 as a reference voltage output unit, a test current generation circuit 103 as a current supply unit, the comparator 104 as the output voltage detecting unit, a logic circuit 105 as a test control unit, a test voltage input part 106, a pre-charge voltage generation circuit 107, etc.

The comparator 104 makes a comparison to determine whether the voltage of the organic EL element 201 as the target of test input to the test voltage input part 106 is higher or lower compared to a reference voltage V_{REF} output by the reference voltage output circuit 102, and outputs the result as a code to the logic circuit 105. The logic circuit 105 gives a command to the reference voltage output circuit 102 for a next reference voltage V_{REF} to be output based on the code.

The reference voltage output circuit 102 outputs a new reference voltage V_{REF} according to the command and the comparator 104 outputs a new code to the logic circuit 105. By repeating the operation, the logic circuit 105 converts the voltage of the organic EL element 201 into digital values based on the plural codes and acquires measurement results.

The test current generation circuit 103 generates a test current to be supplied to the organic EL element 201 as the target of test for the test of the characteristics of the element. Further, pre-charge for previously charging by applying a voltage to the organic EL element 201 is desirable in order that the current flowing in the organic EL element 201 may become stable in a short time. To perform pre-charge, the pre-charge voltage generation circuit 107 generates a pre-charge voltage to be supplied to the organic EL element 201. The reference voltage output circuit 102 also supplies their criterion voltages to the test current generation circuit 103 and the pre-charge voltage generation circuit 107.

The reference voltage output circuit 102 includes a first reference voltage output circuit 102A and a second reference voltage output circuit 102B. The first reference voltage output circuit 102A generates plural first reference voltages with a coarse accuracy of 100 mV, for example, by internally dividing a first criterion voltage range as a predetermined criterion voltage range using resistors. The first reference voltage output circuit 102A selects and outputs one of the plural first reference voltages, and thereby, outputs a first reference voltage V_{R}_{_{—}}_{A} to the comparator 104, outputs a criterion voltage V₃₂ of 3.2 V as a criterion of resolution control and a criterion voltage V_{ADSEL} as a center value of a second criterion voltage range for a second reference voltage V_{R}_{_{—}}_{D} output by the second reference voltage output circuit 102B, which will be described later, to the second reference voltage output circuit 102B, outputs a criterion voltage V_{PC} of the pre-charge voltage to the pre-charge voltage generation circuit 107, and outputs a criterion voltage V₁₆ of 1.6 V as a power supply voltage for generation of the test current to the test current generation circuit 103.

The second reference voltage output circuit 102B generates a bottom criterion voltage V_{BTM} and a top criterion voltage V_{TOP} in the second criterion voltage range from the criterion voltages V₃₂, V_{ADSEL} supplied from the first reference voltage output circuit 102A, internally divides the second criterion voltage range using resistors, and thereby, generates plural second reference voltages with a fine accuracy of 5 mV, for example. The second reference voltage output circuit 102B selects and outputs one of the plural second reference voltages, and thereby, outputs the second reference voltage V_{R}_{_{—}}_{D} to the comparator 104.

The test voltage input part 106 includes a low-pass filter LPF and removes noise in the high-frequency region. Further, according to need, the part is connected to one or two voltage follower circuits. Two voltage follower circuits form a sample hold circuit.

To the logic circuit 105, in addition to the codes input by the comparator 104, a test enable signal EN, a pre-charge signal PC, and a cycle clock CLK are input. The logic circuit 105 selects one of the first reference voltage V_{R}_{_{—}}_{A} generated by the first reference voltage output circuit 102A and the second reference voltage V_{R}_{_{—}}_{D} generated by the second reference voltage output circuit 102B as the reference voltage V_{REF}. Then, in the above described manner, the logic circuit 105 commands the reference voltage output circuit 102 to output a next reference voltage V_{REF} based on the codes input by the comparator 104. Furthermore, on the basis of the plural codes, the logic circuit 105 converts the voltage of the organic EL element 201 as the target of test into digital values and outputs them.

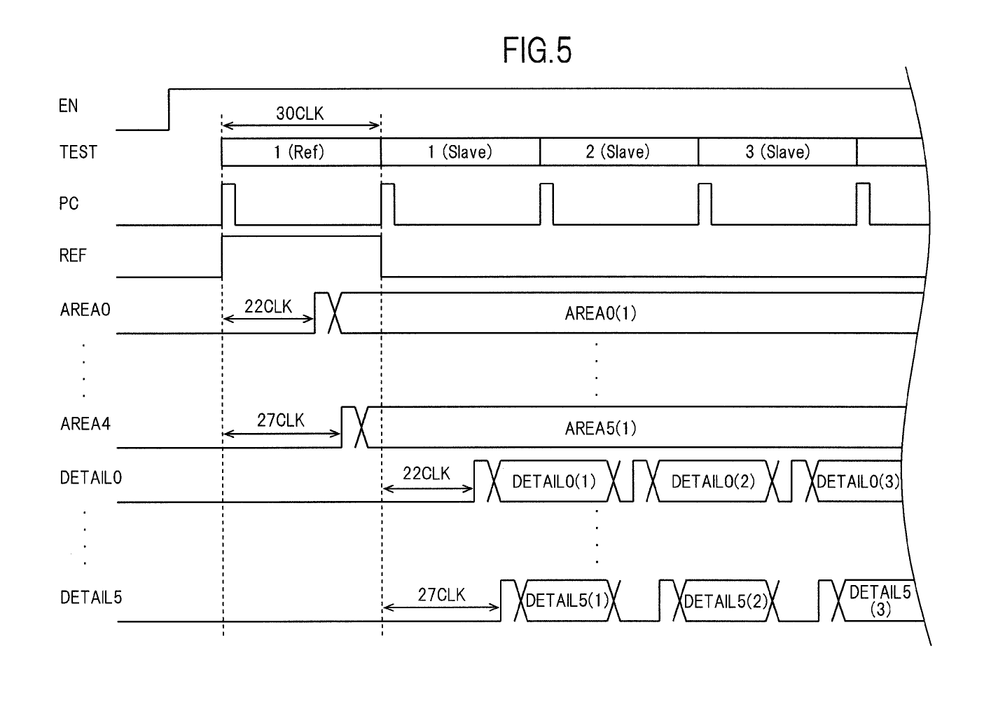

FIG. 5 shows changes with time of driving of the burn-in detection circuit 100. As described above, the characteristic tests of the organic EL elements 201 are performed in the blanking period that is neither the data writing period nor the light emission period out of one screen display period. In the blanking period of one screen display period, it is impossible to test the characteristics of all organic EL elements 201 provided in the display area 15, and accordingly, tests are sequentially performed on parts of the organic EL elements 201 in the respective blanking periods. Note that the characteristics of the elements may be tested in the data writing period or the light emission period, however, here, the tests are performed in the blanking periods in consideration of reduction in time for display data writing or variations of the display control voltage.

In the blanking period, when the characteristic test of the elements becomes possible, the test enable signal EN becomes a high-voltage from a low-voltage and the burn-in detection circuit 100 is turned on. The burn-in detection circuit 100 cyclically performs the characteristic test of the organic EL elements 201. The signal indicating the start of each measurement cycle is the pre-charge signal PC. When the pre-charge signal PC rises, the pre-charge voltage generation circuit 107 supplies a pre-charge voltage to the organic EL element 201 as a target of test to charge the organic EL element 201, and one measurement is performed by successive approximation until the pre-charge signal PC rises next. Here, the cycle of the pre-charge signal PC is referred to as a measurement period, and the measurement periods in a certain blanking period are sequentially referred to as a first measurement period, a second measurement period, a third measurement period, and so on.

Here, measurements include a first measurement as a measurement with coarse accuracy using the first reference voltage output by the first reference voltage output circuit 102A and a second measurement as a measurement with fine accuracy using the second reference voltage output by the second reference voltage output circuit 102B.

A measurement determination signal REF becomes a high-voltage at the first measurement and a low-voltage at the second measurement. Here, in a certain blanking period, the measurement determination signal REF becomes the high-voltage in the first measurement period and the low-voltage in other periods. That is, the signal shows that, in a certain blanking period, the first measurement is performed only in the first period and the second measurements are performed in all of the other periods.

Here, it is assumed that, in a certain blanking period, the organic EL element 201 on which the test is first performed is the organic EL element 201 of a first pixel. In the first measurement period, the first measurement is performed on the organic EL element 201 of the first pixel. The measurement performed in the first measurement period is shown by 1 (Ref) as the first measurement for the first pixel in test type TEST. On the basis of a first measurement result AREA as a measurement result of the first measurement of the first pixel, a second criterion voltage range of the second reference voltage output circuit 102B is determined.

In the second measurement period, the second measurement as a measurement with fine accuracy is performed on the organic EL element 201 of the first pixel in the second criterion voltage range. The measurement performed in the second measurement period is shown by 1 (Slave) as the second measurement for the first pixel in the test type TEST. The logic circuit 105 acquires a second measurement result DETAIL as a measurement result of the second measurement and uses this as a measurement result of the organic EL element 201 of the first pixel.

In the third measurement period, the characteristic test is performed on the organic EL element 201 of a second pixel as a next pixel. However, as described above, in the third measurement period, the measurement determination signal REF is the low voltage, and, in the third measurement period, not the first measurement, but the second measurement is performed on the organic EL element 201 of the second pixel. Accordingly, the measurement performed in the third measurement period is shown by 2 (Slave) as the second measurement for the second pixel in the test type TEST. To the second criterion voltage range of the second reference voltage output circuit 102B necessary for the second measurement, the voltage range determined by the first measurement result AREA of the first pixel in the first measurement period is applied. The logic circuit 105 similarly acquires a second measurement result DETAIL of the second pixel and uses this as a measurement result of the organic EL element 201 of the second pixel.

In the fourth and subsequent measurement periods, similarly, the second measurement is sequentially performed on a third pixel, a fourth pixel, and so on, and the measurements are shown by 3 (Slave) and 4 (Slave) in the test type TEST. Assuming that the number of organic EL elements 201 on which the characteristic test can be performed in a certain blanking period is n, in response to the approach of the end of the certain blanking period, the characteristic test of an nth pixel is ended, the test enable signal EN becomes the low-voltage from the high-voltage, and the burn-in detection circuit 100 is turned off. As described above, the measurements in one blanking period, are limited for the n pixels. In a next blanking period, the test is started from the characteristic test of an (n+1)th pixel as a next pixel, and, in the above described manner, the first measurement of the (n+1)th pixel is performed in a first period, and, in a second and subsequent periods, sequentially, the second measurements of the (n+1)th pixel, an (n+2)th pixel, . . . are performed, and their measurement results are obtained.

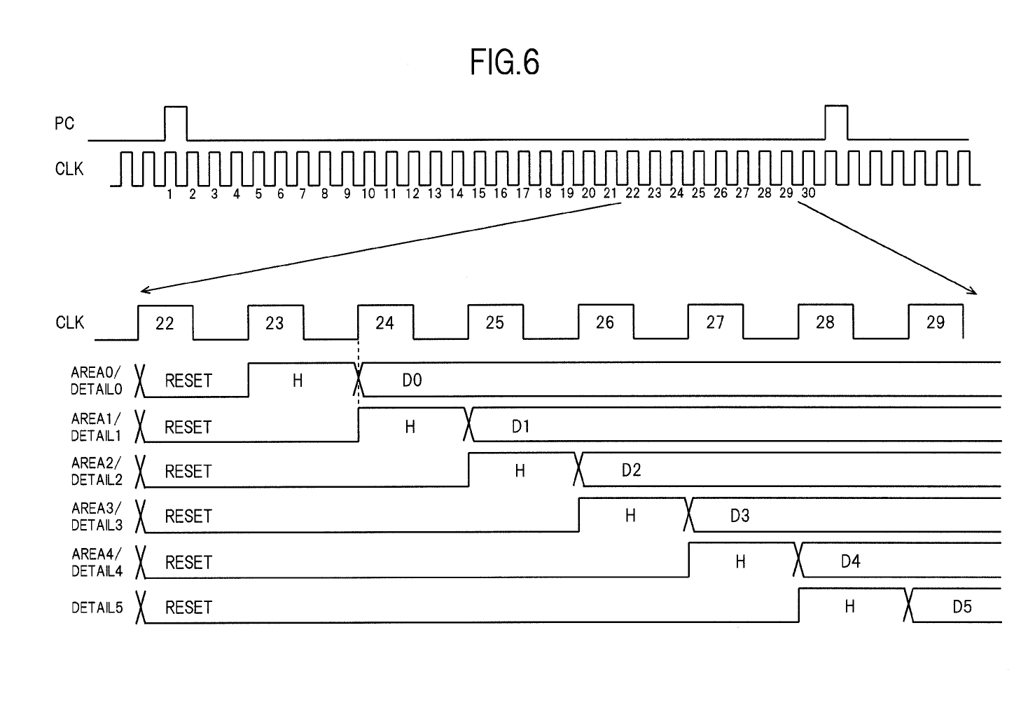

FIG. 6 shows changes with time of driving of the burn-in detection circuit 100. FIG. 6 shows changes with time in one measurement period. As described above, one measurement period is a period for one measurement after the pre-charge signal PC rises and before the pre-charge signal PC rises next. The one measurement period corresponds to 30 cycles of cycle clock CLK. The one measurement period sequentially includes a first cycle clock and a second cycle clock, and so on.

In the first cycle clock, the pre-charge signal PC rises and, as described above, the pre-charge voltage generation circuit 107 supplies a pre-charge voltage to the organic EL element 201 as a target of test to charge the organic EL element 201.

In one measurement, the reference voltage output circuit 102 outputs a reference voltage at each cycle clock, the comparator 104 performs detection of the codes and outputs the codes to the logic circuit 105. In the first measurement, successive approximation is performed at five times and their codes are acquired as a first measurement result AREA. These are sequentially referred to as a first comparison, a second comparison, a third comparison, . . . . Relative to the reference voltage V_{REF}, if the voltage of the organic EL element 201 as the target of test is a high-voltage, the code is set to “0”, and, if the voltage is a low-voltage, the code is set to “1”. As results of the five successive approximations, five codes are obtained, and thereby, 5-bit digital values are obtained as the first measurement result AREA.

In FIG. 6, the code of the first comparison is AREA0, and the code of the second comparison is AREA1. In the third and subsequent comparisons, similarly, the fifth comparison is expressed by AREA4. Note that, after the pre-charge is ended, all of the five (six) codes are reset to “0” in the 22nd cycle clock. In FIG. 6, the resetting is expressed by RESET.

TABLE 1
FOR VDH = 5.3 V

| | | | | | AREA RANGE | | | |
|---|---|---|---|---|---|---|---|---|
| AREA0 | AREA1 | AREA2 | AREA3 | AREA4 | Min. | Max. | VR_A | VADSEL |
| 1 | 1 | 1 | * | * | 5.3 V | — | 5.3 V | (error) |
| 1 | 1 | 0 | 1 | 1 | 5.2 V | 5.3 V | 5.2 V | 5.25 V |
| 1 | 1 | 0 | 1 | 0 | 5.1 V | 5.2 V | 5.1 V | 5.15 V |
| 1 | 1 | 0 | 0 | 1 | 5.0 V | 5.1 V | 5.0 V | 5.05 V |
| 1 | 1 | 0 | 0 | 0 | 4.9 V | 5.0 V | 4.9 V | 4.95 V |
| 1 | 0 | 1 | 1 | 1 | 4.8 V | 4.9 V | 4.8 V | 4.85 V |
| 1 | 0 | 1 | 1 | 0 | 4.7 V | 4.8 V | 4.7 V | 4.75 V |
| 1 | 0 | 1 | 0 | 1 | 4.6 V | 4.7 V | 4.6 V | 4.65 V |
| 1 | 0 | 1 | 0 | 0 | 4.5 V | 4.6 V | 4.5 V | 4.55 V |
| 1 | 0 | 0 | 1 | 1 | 4.4 V | 4.5 V | 4.4 V | 4.45 V |
| 1 | 0 | 0 | 1 | 0 | 4.3 V | 4.4 V | 4.3 V | 4.35 V |
| 1 | 0 | 0 | 0 | 1 | 4.2 V | 4.3 V | 4.2 V | 4.25 V |
| 1 | 0 | 0 | 0 | 0 | 4.1 V | 4.2 V | 4.1 V | 4.15 V |
| 0 | 1 | 1 | 1 | 1 | 4.0 V | 4.1 V | 4.0 V | 4.05 V |
| 0 | 1 | 1 | 1 | 0 | 3.9 V | 4.0 V | 3.9 V | 3.95 V |
| 0 | 1 | 1 | 0 | 1 | 3.8 V | 3.9 V | 3.8 V | 3.85 V |
| 0 | 1 | 1 | 0 | 0 | 3.7 V | 3.8 V | 3.7 V | 3.75 V |
| 0 | 1 | 0 | 1 | 1 | 3.6 V | 3.7 V | 3.6 V | 3.65 V |
| 0 | 1 | 0 | 0 | 1 | 3.5 V | 3.6 V | 3.5 V | 3.55 V |
| 0 | 1 | 0 | 0 | 1 | 3.4 V | 3.5 V | 3.4 V | 3.45 V |
| 0 | 1 | 0 | 0 | 0 | 3.3 V | 3.4 V | 3.3 V | 3.35 V |
| 0 | 0 | 1 | 1 | 1 | 3.2 V | 3.3 V | 3.2 V | 3.25 V |
| 0 | 0 | 1 | 1 | 0 | 3.1 V | 3.2 V | 3.1 V | 3.15 V |
| 0 | 0 | 1 | 0 | 1 | 3.0 V | 3.1 V | 3.0 V | 3.05 V |
| 0 | 0 | 1 | 0 | 0 | 2.9 V | 3.0 V | 2.9 V | 2.95 V |
| 0 | 0 | 0 | 1 | 1 | 2.8 V | 2.9 V | 2.8 V | 2.85 V |
| 0 | 0 | 0 | 1 | 0 | 2.7 V | 2.8 V | 2.7 V | 2.75 V |
| 0 | 0 | 0 | 0 | 1 | 2.6 V | 2.7 V | 2.6 V | 2.65 V |
| 0 | 0 | 0 | 0 | 0 | 2.5 V | 2.6 V | 2.5 V | 2.55 V |

Table 1 shows the first reference voltages V_{R}_{_{—}}_{A} of the first criterion voltage range used for the first measurement and 5-bit digital values of the corresponding first measurement results AREA. The respective 5-bit digital values are expressed by AREA0, AREA1, . . . , AREA4 in the descending order. Here, the highest criterion voltage V_{DH} of the first criterion voltage range is VDH=5.3 V, and the lowest criterion voltage is 2.5 V. With an accuracy of 100 mV, by internally dividing the first criterion voltage range including the lowest criterion voltage and the highest criterion voltage using resistors, 29 first reference voltages V_{R}_{_{—}}_{A} at intervals of 100 mV from 2.5 V to 5.3 V can be generated. The 5-bit digital values of 00000, 00001, 00002, . . . are sequentially assigned to 2.5 V, 2.6 V, 2.7 V, . . . , and 11011 is assigned to 5.2 V.

As described above, in the first measurement, five successive approximations are performed. As shown by AREA0 in FIG. 6, the first comparison is performed in the 23rd clock. Concurrently, the logic circuit 105 commands the reference voltage output circuit 102 to output 4.1 V corresponding to the digital value 10000 as a nearly intermediate value in the first criterion voltage range as the first reference voltage V_{R}_{_{—}}_{A} in the first comparison. As shown in FIG. 6, in the 23rd cycle clock in which the first comparison is performed, AREA0 is a high-voltage, i.e., “1”. AREA1 to AREA4 are low-voltages, i.e., “0”.

In the first comparison, the comparator 104 detects the code as “0” if the test voltage as the voltage of the organic EL element 201 as the target of test is higher than 4.1 V as the first reference voltage V_{R}_{_{—}}_{A} and detects the code “1” if the voltage is lower, and outputs the code to the logic circuit 105. Then, the value of the code is the value of the AREA0 as the highest digital value. As shown in FIGS. 5 and 6, the value is maintained in the 24th and subsequent cycles of the first measurement period. In FIG. 6, the fixed value is expressed by D0.

Assuming that the test voltage is within the first criterion voltage range, that is, no overflow occurs, AREA0 of “1” as the code of the first comparison indicates that the test voltage is from 4.1 V to 5.3 V. The second comparison is performed in the 24th cycle clock. Concurrently, the logic circuit 105 commands the reference voltage output circuit 102 to output 4.9 V corresponding to the digital value 11000 as a nearly intermediate value in the voltage range as the first reference voltage V_{R}_{_{—}}_{A} in the second comparison. As is the case of the first comparison, the comparator 104 detects and outputs the code to the logic circuit 105, and the value of the code is the value of AREA1.

Similarly, AREA0 of “0” as the code of the first comparison indicates that the test voltage is from 2.5 V to less than 4.1 V. In the second comparison performed in the 24th cycle clock, the first reference voltage V_{R}_{_{—}}_{A} is 3.3 V corresponding to the digital value 01000.

The successive approximation is repeated in this manner, the fifth comparison is performed in the 27th cycle clock and all successive approximations in the first measurement are ended, and, through the five successive approximations, the logic circuit 105 acquires their five codes, i.e., the values from AREA0 to AREA4 as the first measurement result AREA.

For example, when the first measurement result AREA is 01111, the first reference voltage V_{R}_{_{—}}_{A} corresponding to the digital value is 4.0 V, and the first measurement result AREA indicates that the test voltage is within the voltage range from 4.0 V to less than 4.1 V. The voltage ranges corresponding to the respective digital values are shown as the minimum voltage (Min) and the maximum voltage (Max) in the AREA ranges in Table 1.

The second criterion voltage range is determined based on the first measurement result AREA. The criterion voltages V_{ADSEL} as the center values of the second criterion voltage range are shown in Table 1. The criterion voltage V_{ADSEL} is an intermediate value of the voltage range of the test voltage determined from the first measurement result. For example, when the first measurement result AREA is 01111, the voltage range of the test voltage is from 4.0 V to less than 4.1 V, and 4.05 V as the intermediate value of the voltage range is the criterion voltage V_{ADSEL}.

Note that, if the measurement result of the first comparison to the third comparison is 111, it means that the test voltage is higher than the highest criterion voltage V_{DH}=5.3 V in the first criterion voltage range and overflow occurs. In this regard, the criterion voltage V_{ADSEL} takes an error value. Similarly, if the first measurement result AREA is 00000, it means that the test voltage is less than 2.6 V. In this case, overflow may occur, but here, the criterion voltage V_{ADSEL} is set to 2.55 V.

As shown in FIG. 4, the first reference voltage output circuit 102A outputs the criterion voltage V_{ADSEL} determined based on the first measurement result AREA acquired by the logic circuit 105 to the second reference voltage output circuit 102B. The second reference voltage output circuit 102B generates the bottom criterion voltage V_{BTM} and the top criterion voltage V_{TOP} in the second criterion voltage range using the input criterion voltage V_{ADSEL}.

TABLE 2

| | | | | | | AD | THRESHOLD |
|---|---|---|---|---|---|---|---|
| SIKI0 | SIKI1 | SIKI2 | SIKI3 | VDLT | V32 − VDLT | RESOLUTION | VALUE |
| 0 | 0 | 0 | 0 | 3.120 V | 80 mV | 2.5 mV | 5 mV |
| 0 | 0 | 0 | 1 | 3.104 V | 96 mV | 3.0 mV | 6 mV |
| 0 | 0 | 1 | 0 | 3.088 V | 112 mV | 3.5 mV | 7 mV |
| 0 | 0 | 1 | 1 | 3.072 V | 128 mV | 4.0 mV | 8 mV |
| 0 | 1 | 0 | 0 | 3.04 V | 160 mV | 5.0 mV | 10 mV |
| 0 | 1 | 0 | 1 | 3.008 V | 192 mV | 6.0 mV | 12 mV |
| 0 | 1 | 1 | 0 | 2.976 V | 224 mV | 7.0 mV | 14 mV |
| 0 | 1 | 1 | 1 | 2.960 V | 240 mV | 7.5 mV | 15 mV |
| 1 | 0 | 0 | 0 | 2.944 V | 256 mV | 8.0 mV | 16 mV |
| 1 | 0 | 0 | 1 | 2.912 V | 288 mV | 9.0 mV | 18 mV |
| 1 | 0 | 1 | 0 | 2.880 V | 320 mV | 10.0 mV | 20 mV |
| 1 | 0 | 1 | 1 | 2.864 V | 336 mV | 10.5 mV | 21 mV |
| 1 | 1 | 0 | 0 | 2.848 V | 352 mV | 11.0 mV | 22 mV |
| 1 | 1 | 0 | 1 | 2.816 V | 384 mV | 12.0 mV | 24 mV |
| 1 | 1 | 1 | 0 | 2.496 V | 704 mV | 22.0 mV | 44 mV |
| 1 | 1 | 1 | 1 | 1.792 V | 1408 mV | 44.0 mV | 88 mV |

Table 2 shows setting voltages that determine the second criterion voltage range. As described above, to the second reference voltage output circuit 102B, the criterion voltage V₃₂ of 3.2 V is input from the first reference voltage output circuit 102A. Further, the second reference voltage output circuit 102B generates a criterion voltage V_{DLT} by internally dividing 3.2 V as a fixed voltage, and the second criterion voltage range is determined by a difference voltage V₃₂−V_{DLT} from 3.2 V as the fixed voltage. The difference voltage V₃₂−V_{DLT} is a voltage difference between the criterion voltage V_{ADSEL} as the intermediate value and the bottom criterion voltage V_{BTM} or the top criterion voltage V_{TOP} in the second criterion voltage range. That is, V_{TOP}=V_{ADSEL}+(V₃₂−V_{DLT}) and V_{BTM}=V_{ADSEL}−(V₃₂−V_{DLT}) hold. These formulae are referred to (Eq. 1).

The criterion voltage V_{DLT} generated by the second reference voltage output circuit 102B is determined by 4-bit control digital values SIKI. For example, if the control digital value SIKI=0100, the criterion voltage V_{DLT}=3.04 V and the difference voltage V₃₂−V_{DLT}=160 mV. In this regard, the AD resolution as the voltage interval of the second reference voltage is 5.0 mV. The AD resolution may be the measurement accuracy in the second measurement.

Note that the control digital values SIKI may be set to predetermined values in advance, or the logic circuit 105 may determine the control digital values SIKI in response to the first measurement result AREA. As will be described below, when a difference between measurement results of two organic EL elements 201 is calculated as correction data, the probability of the difference value is twice the AD resolution. This is used as a threshold value, a measure of the probability of the correction data.

As shown in FIG. 4, the second reference voltage output circuit 102B generates the bottom criterion voltage V_{BTM} and the top criterion voltage V_{TOP}, and further generates the second reference voltage V_{R}_{_{—}}_{D} by internally dividing the second criterion voltage range generated as described above using resistors. For example, when the criterion voltage V_{ADSEL} is 4.05 V and the control digital values SIKI are 0100, the bottom criterion voltage V_{BTM} is 3.890 V and the top criterion voltage V_{TOP} is 4.210 V from the formulae (Eq. 1). In this regard, 65 second reference voltages may be generated at intervals of 5.0 mV from 3.890 V to 4.210 V. That is, the difference voltage V₃₂−V_{DLT} is 160 mV by multiplying the AD resolution 5.0 mV by 32.

The first measurement result AREA of 01111 indicates that the test voltage is in the voltage range from 4.0 V to less than 4.1 V. On the other hand, the second criterion voltage range having the bottom criterion voltage V_{BTM} of 3.890 V and the top criterion voltage V_{TOP} of 4.210 V is larger than the voltage range of the test voltage acquired from the measurement result of the first measurement. That is, the second criterion voltage range is set to a wider range than that of the accuracy of the measurement result of the first measurement. Thereby, in the second measurement, the occurrence of overflow is suppressed and, as described above, as shown in FIGS. 5 and 6, the second measurement of the other pixels may be performed in the second criterion voltage range determined based on the measurement result obtained in the first measurement of the first pixel.

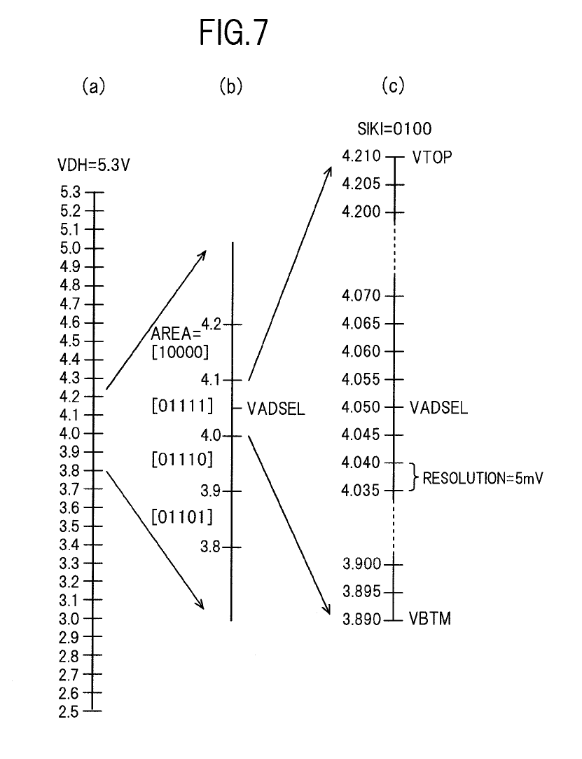

FIG. 7 shows a summary of generation of reference voltages by the reference voltage output circuit 102. FIG. 7(a) shows the first reference voltage V_{R}_{_{—}}_{A} generated by the first reference voltage output circuit 102A. As described above, by internally dividing the first criterion voltage range, 29 first reference voltages may be generated at intervals of 100 mV from 2.5 V to 5.3 V. By the first measurement using one of these first reference voltages as the reference voltage, the first measurement result AREA is acquired. FIG. 7(b) shows a relationship between the first measurement result AREA and the criterion voltage V_{ADSEL}. As described above, when the first measurement result AREA is 01111, it means that the test voltage is within the voltage range from 4.0 V to less than 4.1 V. The criterion voltage V_{ADSEL} is 4.05 V as the intermediate value of the voltage range. FIG. 7(c) shows the second reference voltage V_{R}_{_{—}}_{D} generated by the second reference voltage output circuit 102B. Here, the case where the control digital values SIKI are 0100, that is, the case where the AD resolution as the measurement accuracy in the second measurement is 5.0 mV is shown. As described above, the second criterion voltage range has the intermediate value as the criterion voltage V_{ADSEL} of 4.05 V, and the bottom criterion voltage V_{BTM} of 3.890 V and the top criterion voltage V_{TOP} of 4.210 V. By internally dividing the second criterion voltage range, 65 second reference voltages may be generated at intervals of 5.0 mV from 3.890 V to 4.210 V.

The second measurement is performed using one of the second reference voltages as the reference voltage. The second measurement will be explained using FIGS. 5 and 6. As described above, for example, in the second measurement period, the second measurement of the first pixel is performed, and 1 (Slave) is written in the test type TEST in FIG. 5. As is the case of the first measurement, pre-charge is performed from the first cycle clock in the second measurement.

In the second measurement, six successive approximations are performed, and their results are acquired as the second measurement result DETAIL. Like the first measurement, they are expressed as a first comparison, a second comparison, a third comparison, . . . . As results of the six successive approximations, six codes are obtained, and thereby, a 6-bit digital values are obtained as the second measurement result DETAIL. In FIGS. 5 and 6, like in the first measurement, the first comparison is performed in the 23rd cycle clock, and then, its code is fixed, and then, through the successive approximations, their codes are sequentially fixed. The code of the first comparison is expressed by DETAIL0, the code of the second comparison is expressed by DETAIL1, and sequentially, the code of the sixth comparison is expressed by DETAILS. Accordingly, the sixth comparison is performed in the 28th cycle clock, and the second measurement is ended.

As described above, in the third measurement period, the measurement of the second pixel is performed, and the first measurement is not performed with respect to the second pixel and the measurement is performed using the first measurement result AREA of the first pixel. Thus, in the second and subsequent measurement periods, the value of the first measurement result AREA is constant. On the other hand, in the second and subsequent measurements, the second measurement is performed with respect to each pixel. Regarding the second measurement result DETAIL, in a certain measurement period, after the second measurement result DETAIL is fixed, in the 22nd cycle clock as a next measurement period, all values of the second measurement result DETAIL are reset to “0” and the second measurement is performed on a next pixel.

As above, the configuration and driving of the burn-in detection circuit 100 according to the invention has been described. As below, a correction method of testing the characteristics of the organic EL elements 201 using the burn-in detection circuit 100 and performing correction based on the characteristics will be explained.

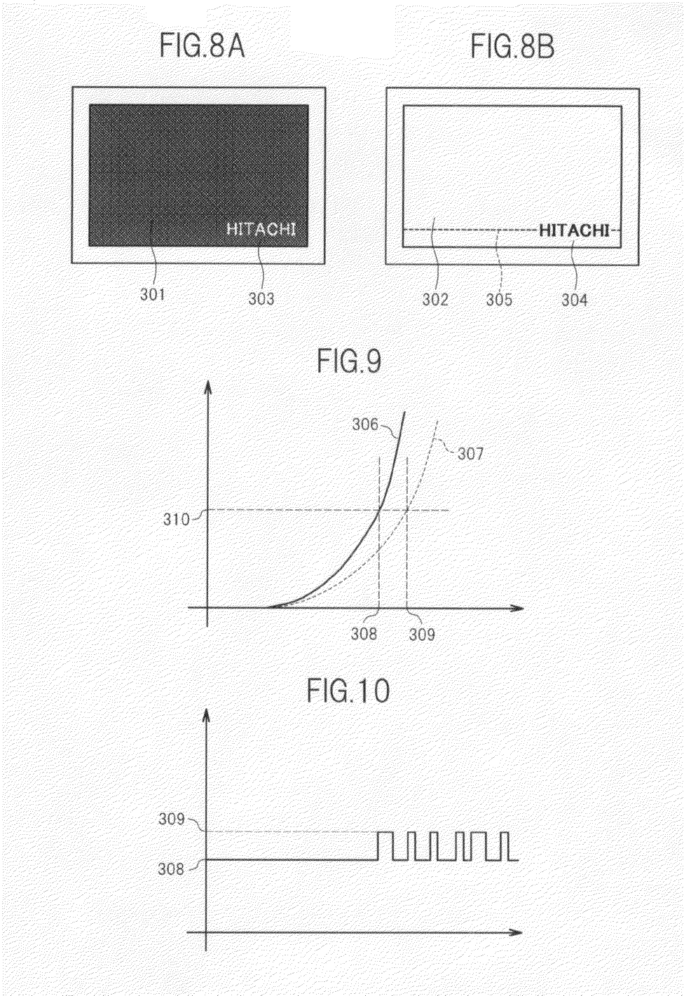

FIGS. 8A and 8B show an example of the case where a burn-in phenomenon occurs. FIG. 8A shows the case where fixed representation 303 is displayed in parts of the display area and black representation 301 is displayed in the other parts. Due to the fixed representation 303 in a long period, deterioration over time occurs in the organic EL elements 201 that display the fixed representation 303. FIG. 8B shows the case where white representation is displayed in the entire display area after the fixed display in the long period. Since the organic EL elements 201 displaying the fixed representation 303 have deteriorated and their characteristics have changed, even in the case where the white representation 302 is displayed with the same brightness in the entire display area, reduction in brightness occurs in the organic EL elements 201 that have displayed the fixed representation 303, and thereby, the reduction is observed by human eyes as a burn-in pattern 304. The burn-in detection circuit 100 sequentially tests the organic EL elements 201 in the display area. Here, the case where the burn-in detection circuit 100 performs characteristic tests on the organic EL elements 201 of the pixels arranged on a common horizontal line 305 shown in FIG. 8B will be explained.

FIG. 9 shows current and voltage characteristics of the organic EL element 201 of the organic EL display device 1 according to the embodiment of the invention. The vertical axis of the graph indicates the current flowing in the element and the horizontal axis indicates the voltage between opposite poles of the element. Further, the characteristics of a normal element 306 are shown by a solid curve and the characteristics of a deteriorated element 307 are shown by a broken curve. The characteristics of the deteriorated element 307 have the gradient of the curve shown in the drawing smaller than the characteristics of the normal element 306. Accordingly, when a constant current 310 is allowed to flow in the normal element 306 and the deteriorated element 307, a voltage 309 of the deteriorated element 307 is higher than a voltage 308 of the normal element 306.

FIG. 10 shows voltages of the organic EL elements 201 on the common horizontal line 305 shown in FIG. 8B. The vertical axis of the graph indicates the voltages of the organic EL elements 201 when the constant current 310 as a test current is allowed to flow in the organic EL elements 201. The horizontal axis of the graph indicates the positions of the organic EL elements 201 on the common horizontal line 305.

On the left of the common horizontal line 305 shown in FIG. 8B, there are normal elements 306, and the voltages of the elements are constant at the voltage 308 of the normal elements 306. On the other hand, on the right of the common horizontal line 305, the deteriorated elements are scattered and the voltages are observed to change to the voltages 309 of the deteriorated elements 307. Here, for simplicity, the fixed representation 303 is used and the degrees of deterioration of the deteriorated elements are constant, and an example of the voltages of the organic EL elements 201 taking only two values of the voltage 308 of the normal elements 306 and the voltage 309 of the deteriorated elements 307 is shown in FIG. 10. However, in practice, the voltages to be tested change depending on the degrees of deterioration over time.

The logic circuit 105 provided in the burn-in detection circuit 100 performs the second measurement on the organic EL element 201 as the target of test and acquires the second measurement result DETAIL. The first measurement result AREA and the second measurement result DETAIL are used as the measurement result of the voltage of the organic EL element 201.

The measurement results of the organic EL elements sequentially tested are stored as correction data, for example. For example, in the case where the tests are sequentially performed on a common horizontal line, the differences between the measurement results of the adjacent organic EL elements 201 on the common horizontal line may be used as correction data.

TABLE 3

| DIFFERENCE CALCULATION | | | |
|---|---|---|---|
| RESULT DETAIL[Pix(n + 1)] − | dct_data | dct_data | dct_data |
| DETAIL[Pix(n)] | [2] | [1] | [0] |
| ≦−3 | 0 | 0 | 0 |
| −2 | 0 | 0 | 1 |
| −1 | 0 | 1 | 0 |
| 0 | 0 | 1 | 1 |
| +1 | 1 | 0 | 0 |
| +2 | 1 | 0 | 1 |
| ≧+3 | 1 | 1 | 0 |
| ERROR | 1 | 1 | 1 |

Table 3 shows 3-bit correction data dct_data. The difference between the second measurement result DETAIL (n) of the nth pixel and the second measurement result DETAIL (n+1) of the (n+1) th pixel is calculated by DETAIL (n+1)−DETAIL (n). As shown in Table 3, here, the values of the differences are correction data dct_data. Further, when the difference is large, that is, the difference is “−3” or less and “+3” or more, the correction data dct_data is 000 and 110, respectively. When overflow occurs in the first measurement and the second measurement, the correction data dct_data are 111 as an error.

The case where the difference between the measurement results of the adjacent pixels is used as the correction data has been explained, however, the correction data are not limited thereto. For example, on a certain horizontal line, the maximum value and the minimum value of the measurement results may be recorded and their difference may be used as correction data for correction. Further, the measurement results of the respective pixels may be stored with position information of the pixels, and fine correction may be performed. In view of the increase of the circuit size for the storage memory and the correctness of the correction, an appropriate correction method may be selected. In addition, here, the comparison is performed with respect to the pixels on the common horizontal line, however, obviously, comparison between the pixels arranged in the vertical direction or comparison between two pixels separately located may be performed.

The burn-in detection circuit 100 according to the invention is characterized in that there is no problem that offset occurs between different comparators 104 because successive approximations are performed using one comparator 104. Further, measurements with two kinds of accuracy of the first reference voltage and the second reference voltage may be possible using one comparator 104. Thereby, measurements in a wider voltage range can be performed and characteristic changes of the elements can be detected with high accuracy while the increase in circuit size is suppressed.

The changes of the current and voltage characteristics of the organic EL elements 201 are more dependent on temperature changes than degrees of deterioration of the elements. Thus, it is necessary that measurements can be performed in a wider voltage range, and, under the same temperature condition, the characteristic changes due to the deterioration of the elements are small. Therefore, when the burn-in detection circuit 100 according to the embodiment performs the characteristic tests of the organic EL elements 201, as shown in FIG. 5, the first measurement is performed only on the first pixel and, using the second criterion voltage range determined based on the measurement result, the first measurement is not performed, but the second measurement is performed on the second and subsequent pixels.

However, in the case where characteristic differences are large between the different elements, both the first measurement and the second measurement may be performed with respect to each pixel. Contrary, in the case where characteristic differences are small between the different elements, it is not necessary to perform the first measurement in each blanking period, and, using the second criterion voltage range determined based on the first measurement that has been once performed, only the second measurement may be performed afterwards. That is, the measurements may be selected in view of the measurement accuracy and efficiency according to the element characteristics.

Further, in the burn-in detection circuit 100 according to the embodiment, the reference voltage output circuit 102 includes the first reference voltage output circuit 102A that outputs the first reference voltages and the second reference voltage output circuit 102B that outputs the second reference voltages, and additionally, may include another reference voltage output circuit that outputs a reference voltage with different accuracy. The circuit may be designed in view of the envisioned voltage range of the test voltage and the necessary measurement accuracy.

As the display device according to the invention, the organic EL display device has been explained as an example, however, the device is not limited to the organic EL display device, but, obviously, the invention may be applied to a display device using other self-emitting elements and a display device having a light source out of the device such as a liquid crystal display device.

While there have been described what are at present considered to be certain embodiments of the invention, it will be understood that various modifications may be made thereto, and it is intended that the appended claims cover all such modifications as fall within the true spirit and scope of the invention.

What is claimed is:

1. A display device comprising:
plural display elements that perform display by control of amounts of flowing currents;
a characteristic testing unit that tests current and voltage characteristics of the respective display elements; and
a display control unit that applies signal voltages to the display elements based on display data to be displayed on the display elements and the characteristics tested by the characteristic testing unit,
wherein the characteristic testing unit comprises
a current supply unit that supplies a test current to the display element as a target of test as one of the plural display elements,
a reference voltage output unit that outputs reference voltages,
an output voltage detecting unit that detects a code of a voltage of the test target display element relative to the reference voltage at each time when the reference voltage is output from the reference voltage output unit, and
a test control unit that allows the reference voltage output unit to sequentially output the reference voltages in response to the codes and acquires a measurement result of the voltage of the test target display element based on the codes.

2. The display device according to claim 1, wherein the reference voltage output unit comprises a first reference voltage output unit that generates a first reference voltage by internally dividing a predetermined first criterion voltage range,
the test control unit acquires a first measurement result of the voltage of the test target display element based on the codes detected using the first reference voltage output by the first reference voltage output unit as the reference voltage,
the reference voltage output unit further comprises a second reference voltage output unit that generates a second reference voltage by internally dividing a second criterion voltage range determined based on the first measurement result, and
the test control unit acquires a second measurement result of the voltage of the test target display element based on the codes detected using the second reference voltage output by the second reference voltage output unit as the reference voltage, and acquires the measurement result of the voltage of the display element based on the second measurement result.

3. The display device according to claim 2, wherein the test control unit allows the reference voltage output unit to output the second reference voltage by internally dividing the second criterion voltage range determined based on the first measurement result of the test target display element, and
further acquires a second measurement result of a voltage of another test target display element based on the codes detected using the second reference voltage as the reference voltage, and acquires the measurement result of the voltage of the other test target measurement element based on the second measurement result.

4. The display device according to claim 2, wherein accuracy of the first measurement result of the voltage of the test target display element is contained in the second criterion voltage range.

5. The display device according to claim 3, wherein accuracy of the first measurement result of the voltage of the test target display element is contained in the second criterion voltage range.
